(19) United States
(12) Patent Application Publication
(10) Pub. No.: US 2011/0047484 A1
(43) Pub. Date: Feb. 24, 2011

(54) USER MANAGEABLE COLLABORATION

(75) Inventors: Charles Mount, Issaquah, WA (US); Brian Moran, Preston, WA (US); Matthew Edward Anderson, Issaquah, WA (US); Brandon Ryan Caplan, Issaquah, WA (US); Leigh B. Caplan, Issaquah, WA (US); William Andrew Loe, III, Seattle, WA (US); Michael Patrick Tierney, Bellevue, WA (US)

Correspondence Address: BOSWELL IP Law, 601 Union Street, SUITE 4200, SEATTLE, WA, 98101-4036, US

(73) Assignee: ONEHUB INC., Bellevue, WA (US)

(21) Appl. No.: 12/544,216

(22) Filed: Aug. 19, 2009

(51) Int. Cl. G06F 3/01

(52) U.S. Cl. 715/753

(57) ABSTRACT

A collaboration system described herein empowers non-technical users to create and manage custom collaboration portals, called hubs. Hubs are easy to manage, often providing a satisfactory default configuration after the user answers questions through a wizard-like interface. The collaboration system may be provided as an Internet-based service that can be accessed by users regardless of their affiliation with a company or other predetermined group. In addition, the system shields users from the systems that provide storage for hub content, so that users can avoid the difficulties of data management. The system may provide one or more hub widgets that provide specific functionality, such as a calendar widget for managing events, a file widget for sharing files, a comments widget for managing electronic discussions, and so forth. Thus, the collaboration system facilitates online collaboration for users without advanced software experience.

### BACKGROUND

Collaborating to create and share documents and other content is recognized as a great way to save time and improve the creation and use of content. Early word processing documents were often created by a single author and then printed or distributed in some other physical form as a final draft. Electronic collaboration allows many authors to contribute to a document and for many users to view the document. There are many types of collaboration. For example, architects collaborate on a building design, engineers collaborate on a car design, software developers collaborate on software source code, legal documents are created by lawyers and reviewed and amended by clients, and so forth.

With the rise of the Internet, sharing of content has become common, both to collaborate on the creation of content and to distribute content to consumers of the content. Sharing content can be performed using simple tools such as email (e.g., emailing a document between two users) or more complex tools such as a custom-designed intranet application for an organization. Content sharing often revolves around a pre-existing relationship between the authors and consumers of the content, such as a project team, family members, schoolmates, or other association. Content today can describe many types of information, including textual information, pictures, tables, mathematical formulas and calculations, architectural designs, schematics, computer source code, videos, audio files, calendars, and any other information content that may be represented in digital form.

Enterprise content management (ECM) refers to the technologies used to capture, store, preserve, and deliver content and documents and content related to organizational processes. ECM tools and strategies allow the management of an organization's unstructured information, wherever that information exists. A subset of ECM is a content management system (CMS), which is computer software used to create, edit, manage, and publish content in a consistently organized fashion. CMSs are frequently used for storing, controlling, versioning, and publishing industry-specific documentation such as news articles, operators' manuals, technical manuals, sales guides, and marketing brochures. The content managed may include computer files, image media, audio files, electronic documents, and Web content. Another type of ECM is a document management system (DMS), which is a computer system (or set of computer programs) used to track and store electronic documents and/or images of paper documents. The term has some overlap with the concepts of Content Management Systems and is often viewed as a component of Enterprise Content Management Systems and related to Digital Asset Management, Document imaging, Workflow systems, and Records Management systems.

Unfortunately, content sharing and collaboration are still too difficult to be used widely. Simple file sharing systems, such as Rapid Share, lack features to enable users to do anything other than transfer files. Because of this, many users still resort to sharing by email. On the other hand, more advanced ECM systems, such as Microsoft SharePoint, involve such a high level of setup and administration (often by a dedicated system administrator) that they are not approachable by many users. Users are forced to return to more traditional means of collaboration, such as videoconferencing, telephones, and face-to-face meetings. In addition, existing systems are often tied to proprietary storage solutions that involve complex management. For example, an ECM application often stores data in a database that a user or system administrator manages. For this and other reasons, these systems are often only used within a corporate intranet with a dedicated information technology (IT) staff.

### BRIEF DESCRIPTION OF THE DRAWINGS

FIG. 1 is a block diagram that illustrates components of the collaboration system, in one embodiment.

FIG. 2 is a flow diagram that illustrates the processing of a client interacting with the hub creation component to create a new hub, in one embodiment.

FIG. 3 is a flow diagram that illustrates processing of the hub design component when in a design mode, in one embodiment.

FIG. 4 is a flow diagram that illustrates processing of the hub sharing component to share a hub with one or more users, in one embodiment.

FIG. 5 is a display diagram that illustrates a user home page of the collaboration system, in one embodiment.

FIG. 6 is a display diagram that illustrates a display page of the collaboration system for creating a hub, in one embodiment.

FIG. 7 is a display diagram that illustrates a display page of the collaboration system for specifying a hub style, in one embodiment.

FIG. 8 is a display diagram that illustrates a hub home page of the collaboration system, in one embodiment.

FIG. 9 is a display diagram that illustrates a design page of the collaboration system, in one embodiment.

FIG. 10 is a display diagram that illustrates a management page of the collaboration system, in one embodiment.

FIG. 11 is a display diagram that illustrates a hub sharing page of the collaboration system, in one embodiment.

FIG. 12 is a display diagram that illustrates an invite users page of the collaboration system, in one embodiment.

### DETAILED DESCRIPTION

A collaboration system is described herein that empowers non-technical users to create and manage custom collaboration portals, called hubs. Unlike previous systems, hubs are easy to manage, often providing a satisfactory default configuration after the user answers one or two questions through a wizard-like interface. In some embodiments, the collaboration system is provided as an Internet based service that can be accessed by users regardless of their affiliation with a company or other predetermined group. For example, users may create hubs for various purposes in their life, such as for sharing content related to a child's soccer team, sharing work-related documents, and sharing family photos or other content. In addition, the system shields users from the systems that provide storage for the content. For example, the system may be centrally managed by a service provider, and may store data using a database, cloud-based storage service, or other storage system.

Typically, a user starts by creating a profile with the system. After logging on with the profile, the user creates a hub. The system may present the user with one or more options, such as whether the hub is to be public (visible to other users) or private/secured (e.g., requiring an invitation or other permission to be visible to a user). The system may provide one or more hub widgets that provide specific functionality, such as a calendar widget for managing events, a file widget for sharing files, a comments widget for managing electronic discussions, and so forth. When creating a hub, the system may allow the user to select a template from a set of templates that define different default widgets to be associated with the new hub. After the system creates the hub, the system offers the user options for configuring the hub and for sharing the hub with other users. Thus, the collaboration system facilitates online collaboration for users without IT or other advanced software experience.

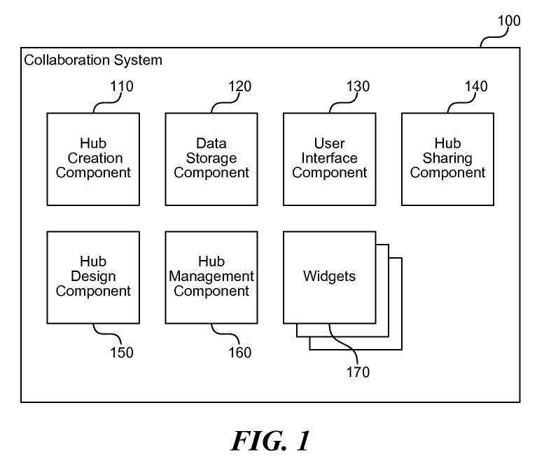

FIG. 1 is a block diagram that illustrates components of the collaboration system, in one embodiment. The system 100 includes a hub creation component 110, a data storage component 120, a user interface component 130, a hub sharing component 140, a hub design component 150, a hub management component 160, and one or more hub widgets 170. Each of these components is described in further detail herein.

The hub creation component 110 manages the creation of new hubs. The component 110 receives information about the new hub, such as a name, description, Uniform Resource Locator (URL), color scheme, initial widgets, and so forth, and stores the hub using the data storage component 120. The hub creation component 110 communicates with the user interface component 130 to provide a user interface through which a user specifies information about the new hub. The hub creation component 110 may provide several ways of creating a hub, such as a short wizard for producing a “quick hub” and a more detailed wizard for producing a more complex hub. For each of these ways of creating a hub, the hub creation component 110 provides an easy interface that can be used by non-technical users to rapidly create intranets, extranets, and content sharing portals.

The data storage component 120 persistently stores hub data across user sessions with the system 100. The data storage component 120 may use a database, storage area network (SAN), cloud-based storage services (e.g., Amazon S3), or other storage system to persistently store hub data. Hub data includes configuration information, such as the name and description of the hub, as well as widget data, such as files stored by a files widget, events stored by a calendar widget, and so forth. The hub data may also include security information, such as a list of users that are allowed to access the hub and roles of each of the users that determines actions each user can perform.

The user interface component 130 provides a user interface for users to provide input and receive output from the system 100. In some embodiments, the system 100 is implemented as a hosted network-based service that can be accessed by multiple clients. The service may provide output as one or more Hypertext Markup Language (HTML) pages, and the clients may use a standard web browser to interact with the service. The user interface component 130 may also provide other interfaces, such as a programmatic interface that provides Extensible Markup Language (XML) or other output for consumption by other applications. Thus, at times the system 100 may interact directly with the user and at times the system may provide data to other applications used by the user (e.g., an Apple iPhone application or a Facebook plug-in).

The hub sharing component 140 manages which users can access a particular hub. Although the system 100 may act as a hosted service accessible to many clients, some hub creators may not want some hubs to be accessible to any Internet user. For example, a hub creator may create a hub related to a confidential project. The hub creator uses the hub sharing component 140 to both inform other users about the hub and to define which users can access the hub. A hub can be public (i.e., open to any user) or private with a specific list of users. The hub creator or another hub administrator can select users through a user interface of the hub sharing component 140, define roles for each selected user, and send an invitation to each selected user.

The component 140 may send invitations through the system 100 so that the user will see invitations when the user logs on. The component 140 may also send invitations to the user through other communication channels, such as via an electronic mail message or text message (e.g., using the Short Message Service (SMS) of a wireless provider). The hub creator may select users with which to share the hub initially during hub creation and may invite new users later throughout the lifetime of the hub. When the hub sends invitations, the hub sharing component 140 may generate a token that is included in a link that the invitation recipient can select to accept the invitation. The token is selected so that it is difficult to guess so that possession of the token is an indicator of the validity and identity of the person responding to the invitation.

The hub design component 150 provides an interface through which a hub administrator can modify the hub layout and select widgets to add to the hub. A hub contains one or more pages that may be displayed as web pages or tabs from a main screen of a hub. Each page has a layout that defines, for example, how many columns of widgets are displayed on the page. A hub administrator uses the hub design component 150 to modify the layout and add/remove widgets to each page. In some embodiments, the hub design component 150 provides a dynamic, editable web page version of the hub that allows the user to select (such as by clicking a mouse) and move widgets on each hub page to a desired location. The component 150 may also allow the user to modify textual elements, like a title, description, or other element. In some embodiments, the hub administrator invokes the hub design component 150 by selecting a hub design mode. In response, the component 150 provides the editable user interface to the hub administrator. When the hub administrator finishes making any changes, the component 150 saves the hub data to the data storage component 120.

The hub management component 160 provides an interface through which a hub administrator can modify settings of the hub. Unlike the hub design component, these settings may include non-visual elements, such as which users can access the hub, any expiration date of the hub, whether the hub is public or private, and so forth. The hub management component 160 allows the hub administrator to make ongoing changes to the hub as the needs of a group using the hub change. Managing a hub is a task that is easily performed by a non-technical user, such as through a familiar web interface. A hub creator is automatically an administrator of the hub and may select one or more additional administrators of the hub that the system 100 will permit to manage and modify the hub configuration. When the administrator finishes modifying the hub, the hub management component 160 stores the changes using the data storage component 120.

The system 100 includes one or more widgets 170 that provide specific functionality to hubs. A widget may perform a variety of functions, and typically includes a displayable interface that appears on at least one page of the hub. For example, a calendar widget may display a rendering of days in a month similar to a paper calendar or a list of scheduled events associated with a calendar. Widgets may also include administrative interfaces, such as for adding new events to a calendar or restricting which actions users of various roles are allowed to perform using the widget. Examples of widgets are the calendar widget previously described, a task widget for managing tasks, a files widget for storing and sharing files among users, a comments widget for managing online discussions, and so forth. The system 100 may be expanded over time by an operator of the system 100 with additional widgets that hub administrators can add to their hub pages.

The computing device on which the collaboration system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

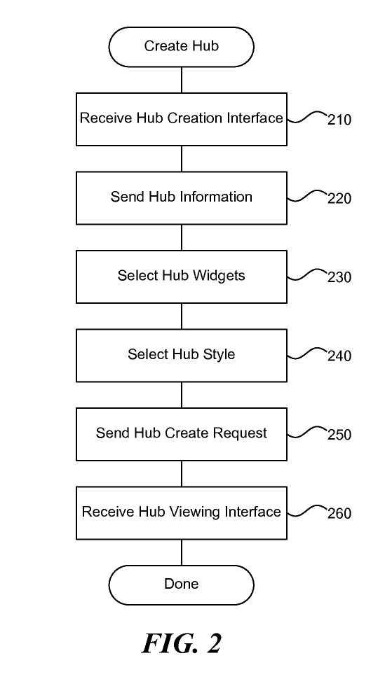

FIG. 2 is a flow diagram that illustrates the processing of a client interacting with the hub creation component to create a new hub, in one embodiment. Beginning in block 210, the client receives a hub creation interface from a hosted service. For example, the client may request a web page and the system responds with an initial hub creation web page. Continuing in block 220, the client sends hub information to the service. For example, the hub information may include a name, description, URL, and whether the hub will be public or private. Continuing in block 230, the client selects one or more hub widgets for the service to include in the new hub. For example, the client may select widgets by selecting among templates that contain predefined widget combinations, by copying an existing hub, or by manually selecting individual widgets. In some embodiments, the client may create an empty hub without any initial widgets.

Continuing in block 240, the client selects a visual style for the new hub. For example, the hub creation interface may include one or more predefined styles and/or color schemes from which a user can choose. Continuing in block 250, the client sends the service a hub creation request that instructs the service to create the hub based on the provided information. When the service receives the request, the service creates the hub and persistently stores the hub settings, including the user that created the hub. Continuing in block 260, the client receives a user interface for viewing the created hub. For example, the service may provide a web page to the client that includes tabs that navigate to individual pages of the hub. Each page may include one or more widgets selected during hub creation. Note that in some embodiments, the collaboration system provides an option for creating a quick hub for sharing content that may omit some of the above steps. For example, when creating a quick hub the system may not ask the user to select widgets or a visual style. After block 260, these steps conclude.

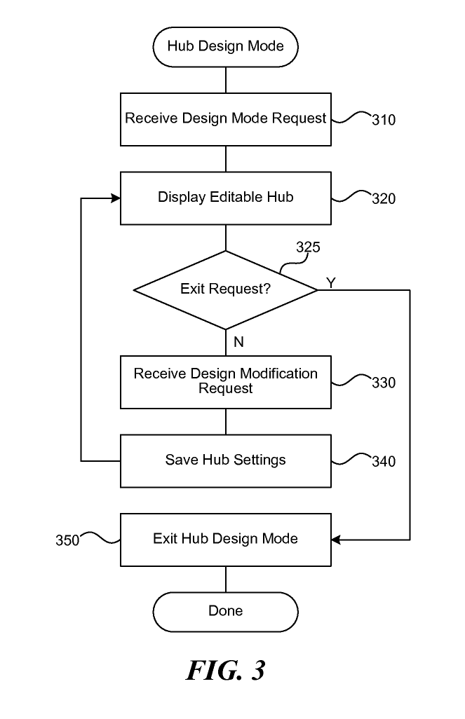

FIG. 3 is a flow diagram that illustrates processing of the hub design component when in a design mode, in one embodiment. Beginning in block 310, the component receives a request to enter design mode. For example, a user may select a design button from a main hub viewing user interface. The design mode allows the user to modify the layout of the hub if the user has appropriate permissions to do so. Continuing in block 320, the component provides an editable hub user interface for display to the user. The editable interface may appear similar to the regular hub viewing interface with controls added for moving, removing, or adding visual elements. In addition, the editable hub user interface includes a button or other control for exiting the hub design mode. Continuing in decision block 325, if the user selects the control for exiting hub design mode then the component jumps to block 350, else the component continues at block 330.

Continuing in block 330, the component receives a design modification request. For example, the user may select one of the displayed controls for editing the hub design. The hub modification request may include many types of changes, including adding a page, modifying the layout of a page, adding widgets to a page, removing widgets from a page, changing information on a page (e.g., a title, logo, or theme), adding data to a specific widget (e.g., uploading a file to a file widget or adding a task to a task widget), and so forth. Continuing in block 340, the component saves modified hub data to a persistent data store. For example, the component may store information about the widgets and how they are arranged on each hub page in a database or other data store. After block 340, the component loops to block 320 to display the updated, editable hub user interface and receive any further modifications. In block 350, reached when the user selects the control for exiting the hub design mode, the component exits the hub design mode and displays the hub with a normal, non-editable user interface. After block 350, these steps conclude.

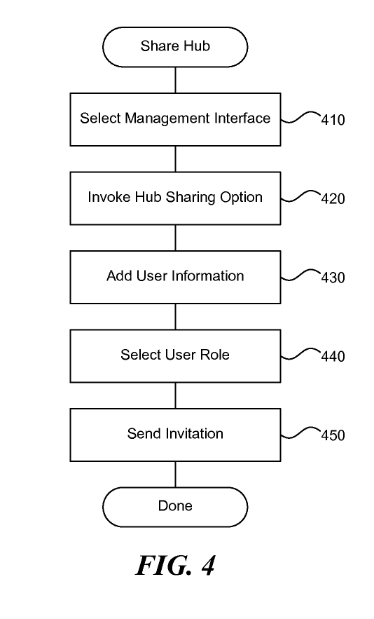

FIG. 4 is a flow diagram that illustrates processing of the hub sharing component to share a hub with one or more users, in one embodiment. Typically, the component is invoked after a user creates a hub to share the new hub with other users. Beginning in block 410, the sharing user selects a management option through the hub user interface. For example, the hub user interface may display a button to users that have sufficient privileges to modify the settings of the hub. Continuing in block 420, the hub sharing component is invoked by the user. For example, the user may select a hub sharing option from within a management user interface of the hub.

Continuing in block 430, the hub sharing component receives information about one or more invited users with which the sharing user wants to share the hub. The information may include a name, email address, and customized message from the sharing user to the one or more invited users. Continuing in block 440, the hub sharing component receives a role for each invited user. For example, the sharing user may select whether the invited user will have administrative or editing privileges over the hub. Continuing in block 450, the hub sharing component sends an invitation to each invited user. The component may send the invitation via email or other communication medium to the invited user. The invitation may include a link to a URL that the invited user can access to use the shared hub. After block 450, these steps conclude.

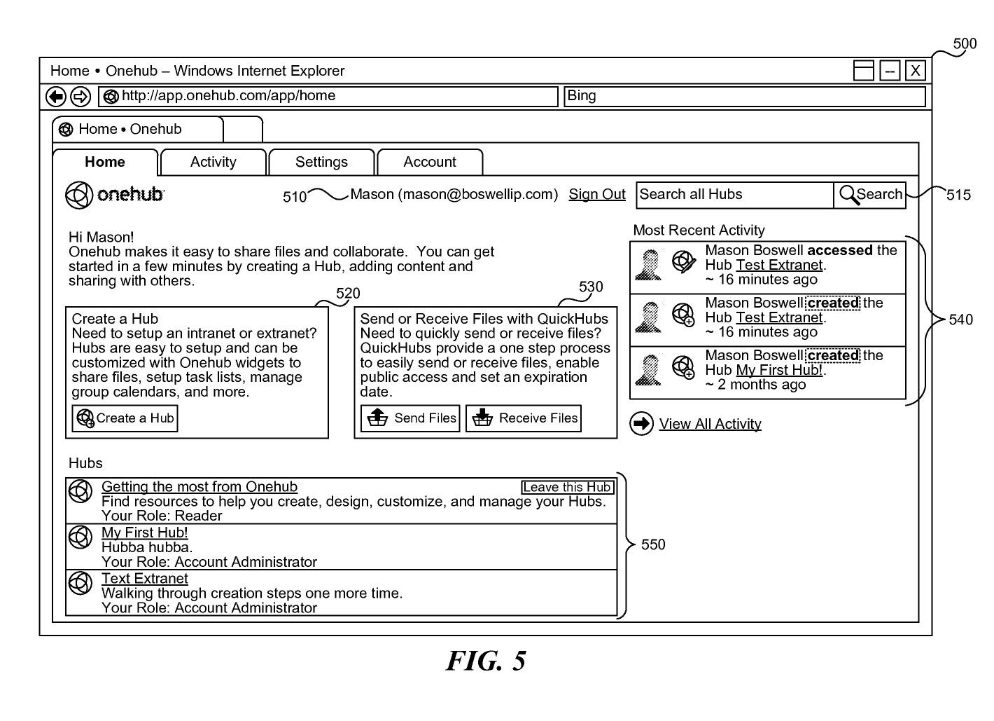

FIGS. 5-12 are display diagrams that illustrates display pages produced by the user interface component described further herein through which users interact with one or more other components of the collaboration system. Those of ordinary skill in the art will recognize that user interfaces may vary widely and include a variety of functions. The display pages illustrated herein are examples of one of many possible implementations of the illustrated functions, and the layout and content of a particular page can be enhanced or simplified by those of ordinary skill in the art to produce numerous interfaces with similar functionality. Thus, these diagrams are provided as illustrative examples that are not intended to limit the possible interfaces that can be displayed by the system.

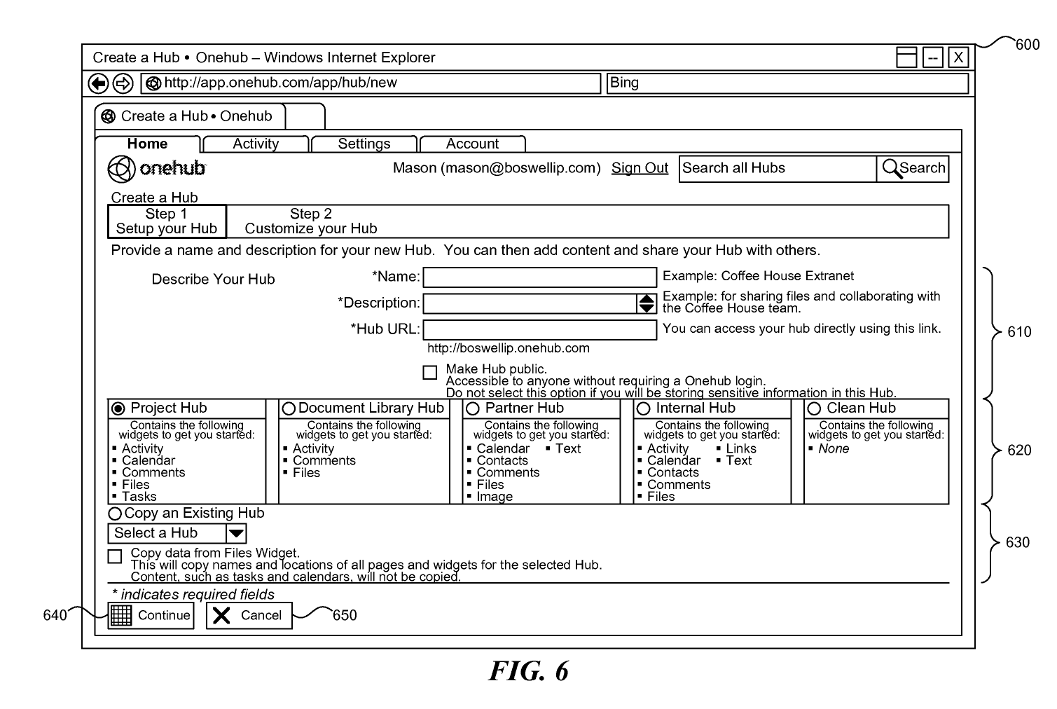

FIG. 5 is a display diagram that illustrates a user home page of the collaboration system, in one embodiment. The system may display the user home page 500 when a user first logs into a hosted service hosting the system and displays information that spans multiple hubs. From the user home page 500, the user can navigate to hubs that the user created or to which the user has been invited by another user. The user home page 500 includes a user login area 510, a search area 515, a create hub widget 520, a quick hub widget 530, an activity log area 540, and a list of hubs 550. The user login area 510 displays the logged on user or if no user has logged on may display username and password boxes for the user to log on. The search area 515 allows the user to enter keywords with which to search data across the hubs to which the user has access. The create hub widget 520 provides the user with a control for invoking the hub creation component to create a new hub. Selecting the control displays an interface like that of FIG. 6.

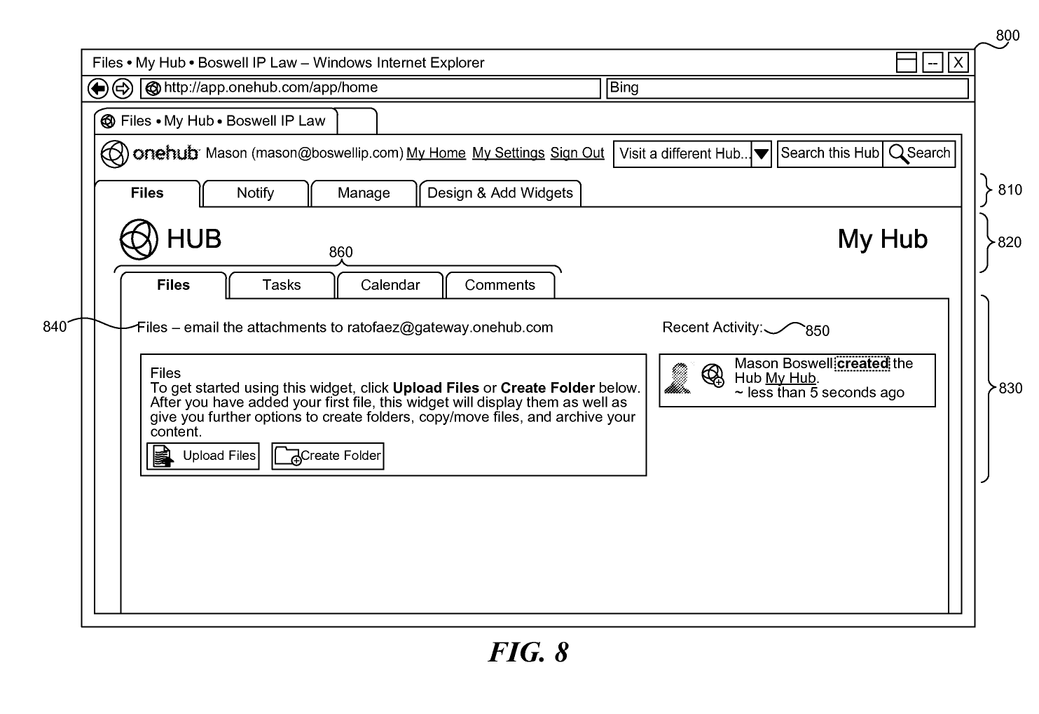

The quick hub widget 530 provides the user with controls for quickly creating hubs to send or receive files. Users may often want to share files through a hub without going through the additional steps typically associated with creating a hub, such as selecting widgets. The quick hub widget 530 allows the user to quickly create these types of hubs. The activity log area 540 displays a log of actions that the user has taken with respect to hubs associated with the user. In some embodiments, the user can set criteria to filter the information displayed in the activity log area 540, such as to filter by activity type. The activity log area 540 may include links in each entry that, when selected, navigate the user to a page related to the activity. For example, if the activity of an entry is uploading a file, a link associated with the entry may refer to a file viewing page. The list of hubs 550 displays a list of hubs associated with the user with links to the home page of each hub. The list of hubs 550 may include hubs that the user previously created as well as hubs to which the user belongs (potentially created by other users). Each entry in the list may include a link to a URL that represents a particular hub home page. Selecting a link takes the user to the home page for that hub, such as the home page of FIG. 8.

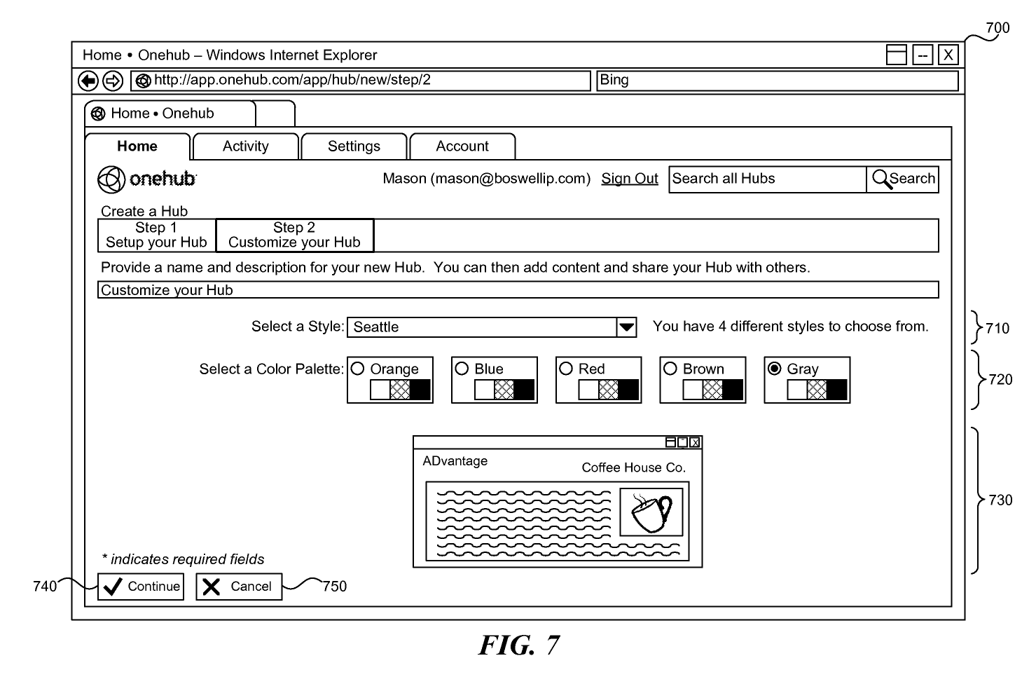

FIG. 6 is a display diagram that illustrates a display page of the collaboration system for creating a hub, in one embodiment. The system may display the display page 600 when a user selects the create hub option from the user home page of FIG. 5. The display page 600 includes a hub information area 610, a template selection area 620, a copy hub area 630, a continue button 640, and a cancel button 650. The hub information area 610 receives details about the new hub, such as a name for the hub, a description, a URL, and whether the hub should be public or private. The template selection area 620 allows the user to select a predefined group of widget for the new hub based on the user's purpose for the hub. For example, a document library hub template includes an activity widget, a comments widget, and a files widget. The copy hub area 630 allows a user to select an existing hub from which to copy a set of widgets for the new hub. The continue button 640 commits the user's selections on the display page 600 and moves to the next page, such as that of FIG. 7. The cancel button 650 abandons the user's selections on the display page 600 and returns the user to a previous page, such as the user home page of FIG. 5.

FIG. 7 is a display diagram that illustrates a display page of the collaboration system for specifying a hub style, in one embodiment. The system may display the display page 700 as a second hub creation page, such as after the user leaves the page of FIG. 6. The display page 700 includes a style selection area 710, a color selection area 720, a preview area 730, a continue button 740, and a cancel button 750. The style selection area 710 allows the user to select a style that affects how the system displays a new hub. The style may affect fonts, colors, title positioning, and other visual elements of the hub. The style selection area 710 may include custom themes created by users or may allow the current user to create a new custom theme. The color selection area 720 allows the user to select a color palette for the new hub. The color palette may include colors for various visual elements of the hub, such as a page background, tab background, font colors, logo colors, and so forth. The preview area 730 displays a preview of the hub's main page with the selected style and color palette applied. As the user selects new colors or styles, the preview area 730 may update to provide a dynamic preview of the user's selections. The continue button 740 commits the user's selections on the display page 700 and creates the hub. The cancel button 750 abandons the user's selections on the display page 700 and returns the user to a previous page, such as the user home page of FIG. 5 or the hub creation page of FIG. 6.

FIG. 8 is a display diagram that illustrates a hub home page of the collaboration system, in one embodiment. The system may display the hub home page 800 when a user navigates to the URL of a hub or selects a hub link from the user's home page. The hub home page 800 includes a menu bar 810, a title area 820, and a widget display area 830. The menu bar 810 includes options for interacting with the hub, such as for sharing the hub with other users, sending notifications to users of the hub, managing the hub configuration, and entering design mode to add, remove, or reposition widgets associated with the hub. The menu bar 810 may be separate from other menu bars displayed, for example, for cross-hub functions. The options in the menu bar 810 may vary based on the logged in user. For example, the system may not display the design mode option to users without permission to modify the hub design. The title area 820 displays summary information about the hub, such as a title and description. The hub creator may provide this information during hub creation or after the hub is created by managing the hub. The widget display area 830 includes any widgets selected by a hub administrator to be part of the hub. The widgets may be part of a predefined template selected during hub creation or may be added by an administrator using the hub design mode. The widget display area 830 in this example includes a files widget 840 for sharing files and an activity log widget 850 that displays a list of actions taken with respect to the hub. The widget display area 830 also includes tabs 860 for viewing other widgets associated with the hub.

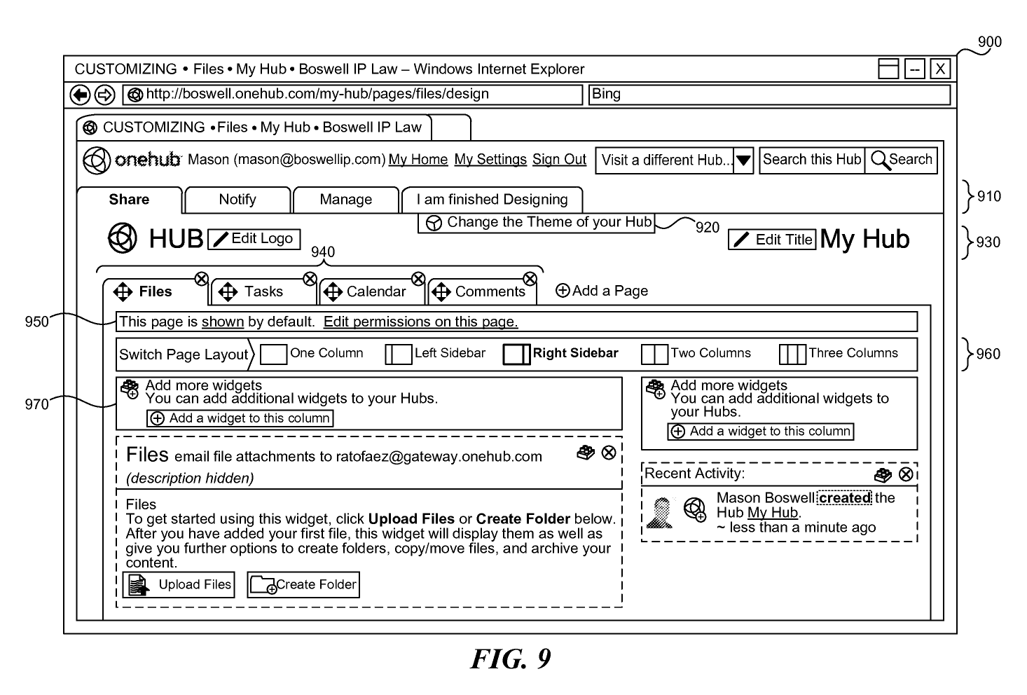

FIG. 9 is a display diagram that illustrates a design page of the collaboration system, in one embodiment. The system may display the design page 900 when a user selects the design mode from the hub home page or other page. The design page 900 appears similar to the hub home page of FIG. 8, but includes several options for editing the content of the hub. Like the hub home page, the design page 900 may include a menu bar 910 for interacting with the hub, including leaving the design mode and returning to the normal display mode. The design page 900 may also include a theme change option 920, an edit title option 930, removable tabs 940, a permission change option 950, a layout selection option 960, and one or more add widget controls 970. Those of ordinary skill in the art will recognize the functionality of these options to produce dynamically editable web pages. For example, the removable tabs 940 allows a user to remove a tab by selecting an X displayed on the tab, so that the tab will no long appear on the hub home page. The layout selection option 960 allows the user to specify how many columns of widgets a particular tab of the hub will display. The add widgets control 970 allows a user to add new widgets to the column or other location where the add widget control 970 is located.

The system may also allow the user to drag and drop widgets to new locations on the design page 900. In some embodiments, the design page 900 contains Asynchronous JavaScript and XML (AJAX) code that allows the design page 900 to receive dynamic layout information while limiting bandwidth to a hosting server. The design page 900 allows ordinary users (e.g., non-developers) to customize hubs without assistance from a familiar web-based or other interface. For example, a user can easily drag and drop widgets to various locations on a page or to other pages of a hub to specify the layout desired by the user.

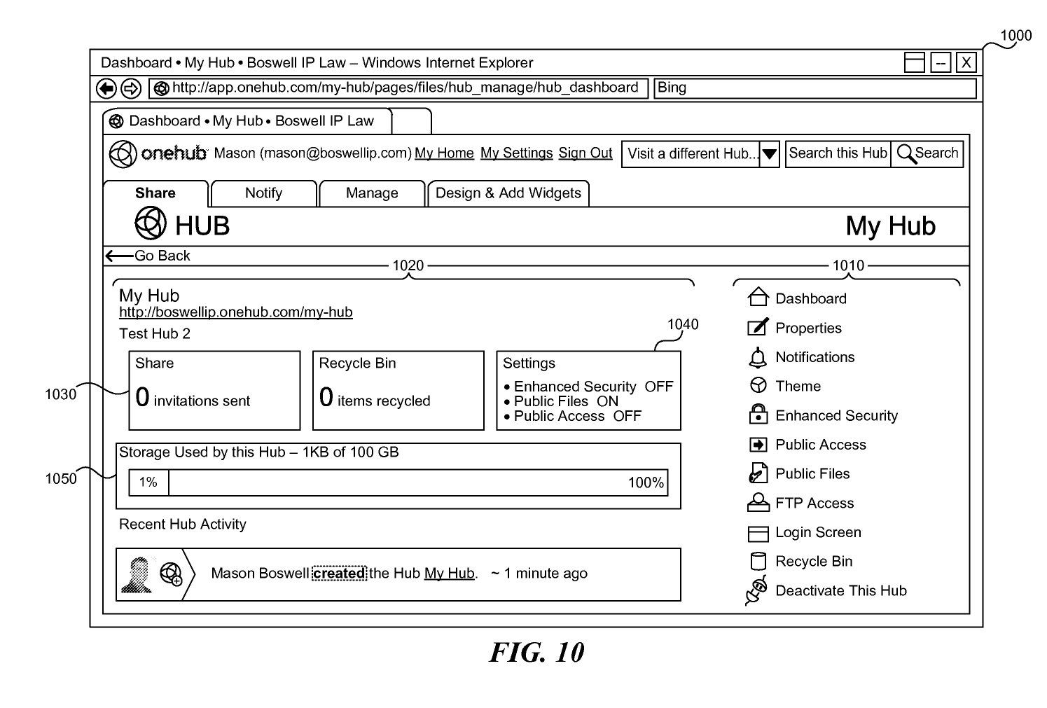

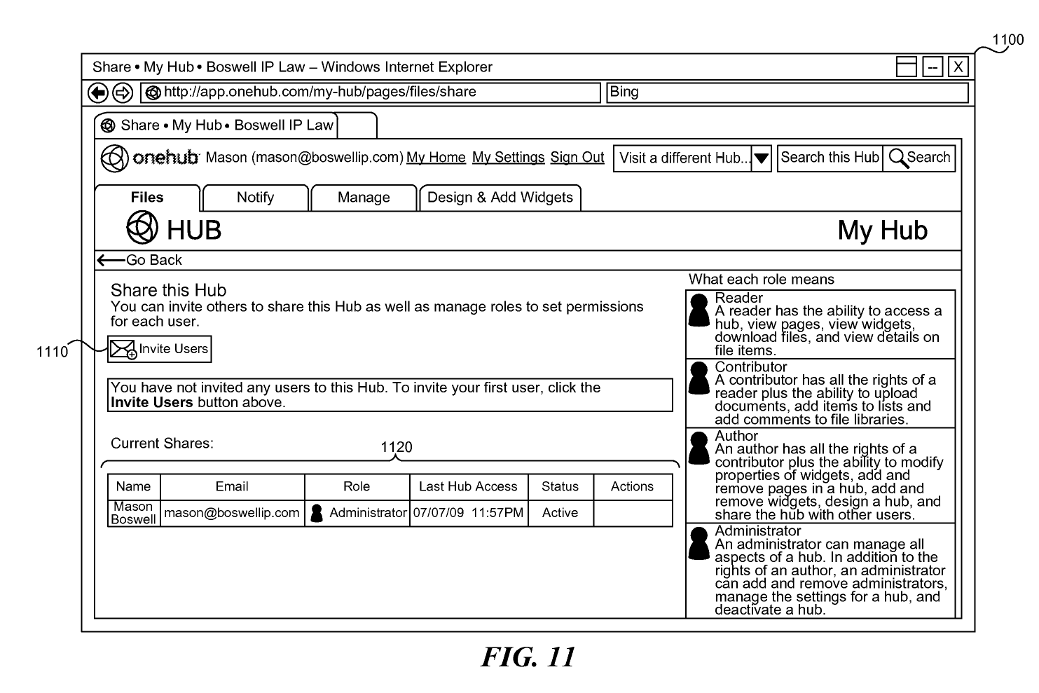

FIG. 10 is a display diagram that illustrates a management page of the collaboration system, in one embodiment. The management page 1000 may be displayed when a user selects a manage option from the hub home page or other page. The management page 1000 includes a category selection area 1010 and a settings area 1020. The category selection area 1010 allows the user to select a category of settings that the user wants to view or modify. When the user selects a category, the system updates the settings area 1020 with settings applicable to the selected category. In this example, the settings area 1020 displays dashboard settings of the hub, including, for example, a share hub option 1030, settings links 1040, and a hub information area 1050. The share hub option allows the user to share the hub with other users, such as through the interface illustrated in FIG. 11. The settings links 1040 provide specific settings that the user can turn on or off, such as public access to the hub. The hub information area 1050 provides information about the hub, such as the current amount of a storage quota in use by the hub.

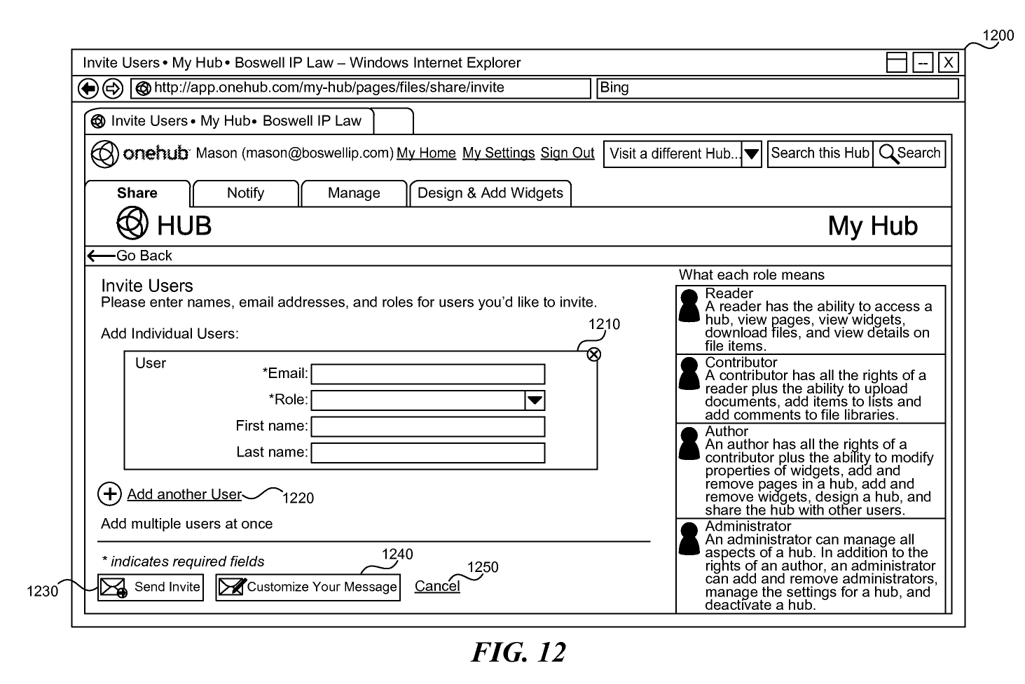

FIG. 11 is a display diagram that illustrates a hub sharing page of the collaboration system, in one embodiment. The hub sharing page 1100 may be displayed when a user selects an option to share a hub with other users. The hub sharing page 1100 includes an invite users button 1110 and a list of current users 1120. The invite users button allows the user to share the hub with new users, and may invoke an interface such as that of FIG. 12. Whether the user can invite other users may depend upon a role or privilege level associated with the user. The list of current users 1120 displays a list including the hub creator and any users that have been invited to use the hub. The list may include information such as each user's role, the last time the user accessed the hub, the user's name, and so forth.

FIG. 12 is a display diagram that illustrates an invite users page of the collaboration system, in one embodiment. The invite users page 1200 may be displayed when a user selects an option to share a hub with other users. The invite users page 1200 includes a user information area 1210, an add user option 1220, a send invite button 1230, a customize message button 1240, and a cancel button 1250. The user information area 1210 receives information about a user to be invited to use the hub. The information may include an email address or other contact address, a role for the user, and identifying information about the user, such as a name. The add user option 1220 allows the user of the invite users page 1200 to invite additional users at the same time. In some embodiments, the system receives groups of multiple email addresses so that the user can invite multiple users at the same time. The send invite button 1230 causes the system to send a default invitation message to the specified users. The customize message button 1240 allows the user to specify custom text to accompany an invitation to one or more other users. The cancel button 1250 leaves the invite users page 1200 without sending an invitation.

In some embodiments, the collaboration system displays a running audit trail of at least some actions performed by one or more users related to a hub. For example, the main page of a hub may contain a widget in the right column that displays an activity log with entries for each action taken by a user. Entries may contain a record of when a user created a hub, when a user uploaded a file to the hub, and other significant events that may be of interest to other users of the hub. Users of the hub can browse the activity log to stay up to date about events that have occurred since each user last viewed the hub. Users may also elect to show or hide events that the activity log displays based on event criteria, such as type of event, user that initiated the event, and so on.

In some embodiments, the collaboration system associates a role with each user and hub that defines the actions the user can perform on the hub. For example, the system may include reader, contributor, author, and administrator roles. A reader has the ability to access a hub, view pages, view widgets, download files, and view details on file items. A contributor has all the rights of a reader plus the ability to upload documents, add items to lists, and add comments to file libraries. An author has all the rights of a contributor plus the ability to modify properties of widgets, add and remove pages in a hub, add and remove widgets, design a hub, and share the hub with other users. An administrator can manage all aspects of a hub. In addition to the rights of an author, an administrator can add and remove administrators, manage the settings for a hub, and deactivate a hub. In some embodiments, the system allows an administrator to allow public access (i.e., non-authenticated users) to a hub and to assign a default role (e.g., reader) to associate with unknown users. Alternatively or additionally, the system may allow the administrator to control granular restrictions, access to widgets, and information contained in widgets on a per-user basis, by role of user, or make access public.

In some embodiments, the collaboration system allows users to search hub data and/or to search data across hubs associated with a user and public hubs accessible by all users. For example, the system may provide a search box in the user interface into which a user can type one or more keywords or phrases that the system will identify in content stored in one or more hubs. The system may provide links to hub pages containing the identified content. Search provides an alternative way to find and navigate to content stored in hubs.

In some embodiments, the collaboration system expires hubs and information within hub widgets after a specified period. For example, the system may receive an expiration time from a hub creator when the hub is created or may use a default expiration time based on a hub type. For example, a hub created for the purpose of sharing files may expire after a short period, while a project-based hub may not expire or be set to expire after the expected completion date of the project. The system may also trigger expiration based on certain events, such as a period (e.g., one month) of no activity related to a hub. Expiring hubs allows the system to recover data storage space for use by other hubs. For example, a files widget may expire files after a particular configurable interval after a user creates the file, such as to satisfy company data retention policies.

In some embodiments, the collaboration system enforces user limits and storage quotas. For example, the system may provide each user with a set number of hubs that the user can create and/or a set amount of data storage space that hubs created by the user can consume. The system may set quotas based on a subscription level or price tier associated with the user or hub, so that users can pay the operator of the system for more hubs and/or data storage space.

In some embodiments, the collaboration system translates or transcodes information uploaded into a hub or widget in a hub for more convenient or appropriate display. For example, the system may transcodes a video of an initial bit rate into a video with a lower bit rate for easy download by client computers with slower network connections. The system may perform translations based on a subscription level or price tier associated with the user or hub, so that users can pay the operator of the system for particular encodings, higher fidelity renderings, or other types of processing.

In some embodiments, the collaboration system provides alternative interfaces to files widgets. When uploading files, the system may provide multiple interfaces for uploading files, including a Sun Java application, an Adobe Flash form, or an HTML POST. The system may also receive files for the files widget via File Transfer Protocol (FTP) or other file transfer specifications. The system may also receive files for the files widget as attachments to email sent to a designated email address for each file widget. When viewing files, the system may provide files through similar interfaces, as well as providing a separately accessible URL for each file. This allows hub users to share links to individual files that are hosted in a hub with other users. In some embodiments, the system provides versioning for files so that updates to files are tracked and users can access or identify specific file versions. For example, one user may upload a document, creating a first version of the document, and a second user may modify the document, creating a second version of the document.

In some embodiments, the collaboration system modifies the login process based on how a user invokes the system. For example, if a user visits a web site associated with the system with a hub-specific URL and the user is not logged in, then the system provides the user with a hub-specific login page. Upon supplying sufficient credentials, the system displays the home page of the hub associated with the hub-specific URL, such as that described with reference to FIG. 8. Alternatively or additionally, if a user who was previously invited to be a member of only one hub visits a web site associated with the system and the user is not logged in, after successful login the system displays the home page of the hub of which the user is a member. In other situations, such as when a user visits a main, cross-hub home page of a web site associated with the system and the user is associated with multiple hubs, the system may display a user home page, such as that described with reference to FIG. 5.

From the foregoing, it will be appreciated that specific embodiments of the collaboration system have been described herein for purposes of illustration, but that various modifications may be made without deviating from the spirit and scope of the invention. Accordingly, the invention is not limited except as by the appended claims.

I/We claim:

1. A computer-implemented method for creating a collaboration hub, the method comprising:
receiving a hub creation interface from a hosted service;
sending to the hosted service information describing the collaboration hub;
selecting one or more hub widgets for the service to include in the new collaboration hub;
sending to the hosted service a hub creation request that instructs the service to create the hub based on the sent hub information and selected hub widgets; and
receiving from the hosted service a user interface for viewing the created hub,
wherein the preceding steps are performed by at least one processor.

2. The method of claim 1 wherein the hub creation interface comprises a web page received from the hosted service.

3. The method of claim 1 wherein the information describing the collaboration hub comprises at least one of a name, a description, a Uniform Resource Locator (URL), and an indication of whether the hub will be public or private.

4. The method of claim 1 wherein selecting one or more hub widgets comprises selecting widgets by selecting a template that contains a predefined widget combination.

5. The method of claim 1 wherein selecting one or more hub widgets comprises selecting widgets by copying widgets in an existing hub.

6. The method of claim 1 wherein selecting one or more hub widgets comprises selecting widgets by individually selecting widgets.

7. The method of claim 1 further comprising, before sending the hub creation request, selecting a visual style for the new hub and including the selected style in the request.

8. The method of claim 1 wherein the hosted service, upon receiving the hub creation request, creates the hub and persistently stores the hub information and selected widgets as hub settings.

9. The method of claim 1 wherein receiving a user interface for viewing the created hub comprises receiving a web page that includes one or more of the selected widgets.

10. A computer system for user manageable collaboration, the system comprising:
a processor and memory configured to execute software instructions;
a hub creation component configured to manage creation by users of new collaboration hubs;
a data storage component configured to persistently store hub data across user sessions;
a user interface component configured to provide a user interface for users to provide input and receive output from the system;
a hub sharing component configured to manage which users can access a particular hub;
a hub design component configured to provide an interface through which a hub administrator can modify the hub layout and select widgets to add to the hub;
a hub management component configured to provide an interface through which a hub administrator can modify configuration settings of the hub; and one or more widgets configured to each provide specific functionality to the hub.

11. The system of claim 10 wherein the hub creation component is further configured to receive information about a new hub and store the new hub using the data storage component.

12. The system of claim 10 wherein the hub creation component is further configured to communicate with the user interface component to provide a user interface through which a user specifies information about a new hub.

13. The system of claim 10 wherein the hub data stored by the data storage component includes at least one of configuration information associated with a hub, an indication of one or more widgets associated with the hub, widget data specific to the one or more widgets, and security information that describes users that are allowed to access the hub.

14. The system of claim 10 wherein the user interface component is further configured to provide a hosted network-based service that can be accessed by multiple clients as one or more Hypertext Markup Language (HTML) pages.

15. The system of claim 10 wherein the user interface component is further configured to provide a programmatic interface through which applications can access hub data managed by the data storage component.

16. The system of claim 10 wherein the hub sharing component is further configured to send invitations to one or more users that a hub administrator grants access to a hub.

17. The system of claim 10 wherein the hub design component is further configured to provide a dynamic, editable web page version of the hub that allows the hub administrator to select widgets associated with one or more pages of the hub.

18. The system of claim 10 wherein the hub management component and hub design component are further configured so that managing a hub is a task that is easily performed by a non-technical user through a familiar web interface.

19. The system of claim 10 wherein the one or more widgets are selected from the group consisting of a files widget, a calendar widget, a tasks widget, an activity widget, a comments widget, an image widget, a contacts widget, a links widget, a Really Simple Syndication (RSS) widget, a text widget, and a video widget.

20. A computer-readable storage medium comprising instructions for controlling a computer system to share a collaboration hub with one or more users, wherein the instructions, when executed, cause a processor to perform actions comprising:
receiving from a sharing user of the computer system a selection of a hub sharing user interface;
receiving information about one or more invited users with which the sharing user wants to share the collaboration hub;
receiving a role for each invited user that identifies one or more privileges to be granted to the invited user; and
sending an invitation to each invited user, wherein each invitation includes a link to a Uniform Resource Locator (URL) that the invited user can access to use the shared hub.
